(19) United States
(12) Patent Application Publication
(10) Pub. No.: US 2025/0254719 A1
(43) Pub. Date: Aug. 7, 2025

(54) CONTROLLING ACCESS FOR DEVICES WITH DIFFERENT CAPABILITIES

(71) Applicant: NOKIA TECHNOLOGIES OY, ESPOO (FI)

(72) Inventors: Samuli Heikki TURTINEN, Oulu (FI); Jussi-Pekka KOSKINEN, Oulu (FI)

(21) Appl. No.: 19/186,536

(22) Filed: Apr. 22, 2025

Related U.S. Application Data
(63) Continuation of application No. 18/704,362, filed on Apr. 24, 2024.
(60) Provisional application No. 63/272,551, filed on Oct. 27, 2021.

(51) Int. Cl. H04W 74/00; H04W 72/51; H04W 74/0833

(52) U.S. Cl. CPC H04W 74/004; H04W 72/51; H04W 74/0833

(57) ABSTRACT

Systems, methods, apparatuses, and computer program products for control of access for devices with different capabilities are provided. For example, a method may include receiving, from a user equipment, an indication in a random access message. The method may also include determining whether the user equipment has one receive branch or two receive branches based on the indication. The method may further include communicating with the user equipment based on the determination that the user equipment has one receive branch or two receive branches.

### CROSS-REFERENCE TO RELATED APPLICATION

This application is a Continuation of co-pending U.S. patent application Ser. No. 18/704,362, filed on Apr. 24, 2024, which is the National Stage of PCT International Application No. PCT/FI2022/050628, filed on Sep. 20, 2022, and which claims the benefit of U.S. Provisional Patent Application No. 63/272,551, filed on Oct. 27, 2021. The entire content of the above-referenced applications is hereby incorporated by reference.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for controlling access for devices with different capabilities.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus may include at least one processor and at least one memory including computer program instructions. The at least one memory and the computer program instructions can be configured to, with the at least one processor, cause the apparatus at least to perform receiving, from a user equipment, an indication in a random access message. The at least one memory and the computer program instructions can also be configured to, with the at least one processor, cause the apparatus at least to perform determining whether the user equipment has one receive branch or two receive branches based on the indication. The at least one memory and the computer program instructions can further be configured to, with the at least one processor, cause the apparatus at least to perform communicating with the user equipment based on the determination that the user equipment has one receive branch or two receive branches.

An embodiment may be directed to an apparatus. The apparatus may include at least one processor and at least one memory including computer program instructions. The at least one memory and the computer program instructions can be configured to, with the at least one processor, cause the apparatus at least to perform transmitting, from a user equipment to a network element, an indication in a random access message. The indication can indicate to the network element as to whether the user equipment has one receive branch or two receive branches. The at least one memory and the computer program instructions can also be configured to, with the at least one processor, cause the apparatus at least to perform receiving a response from the network element based on the determination. The at least one memory and the computer program instructions can further be configured to, with the at least one processor, cause the apparatus at least to perform communicating, by the user equipment, with the network based on the determination that the user equipment has one receive branch or two receive branches.

An embodiment may be directed to a method. The method may include receiving, from a user equipment, an indication in a random access message. The method may also include determining whether the user equipment has one receive branch or two receive branches based on the indication. The method may further include communicating with the user equipment based on the determination that the user equipment has one receive branch or two receive branches.

An embodiment may be directed to a method. The method may include transmitting, from a user equipment to a network element, an indication in a random access message. The indication can be configured to indicate to the network element as to whether the user equipment has one receive branch or two receive branches. The method may also include receiving a response from the network element based on the determination. The method may further include communicating, by the user equipment, with the network based on the determination that the user equipment has one receive branch or two receive branches.

An embodiment may be directed to an apparatus. The apparatus may include means for receiving, from a user equipment, an indication in a random access message. The apparatus can also include means for determining whether the user equipment has one receive branch or two receive branches based on the indication. The apparatus may further include means for communicating with the user equipment based on the determination that the user equipment has one receive branch or two receive branches.

An embodiment may be directed to an apparatus. The apparatus may include means for transmitting, from a user equipment to a network element, an indication in a random access message. The indication can indicate to the network element as to whether the user equipment has one receive branch or two receive branches based. The apparatus may also include means for receiving a response from the network element based on the determination. The apparatus may further include means for communicating, by the user equipment, with the network based on the determination that the user equipment has one receive branch or two receive branches.

An embodiment may be directed to a non-transitory computer readable medium comprising program instructions stored thereon for performing receiving, from a user equipment, an indication in a random access message. The program instructions may also be for performing determining whether the user equipment has one receive branch or two receive branches based on the indication. The program instructions may further be for performing communicating with the user equipment based on the determination that the user equipment has one receive branch or two receive branches.

An embodiment may be directed to a non-transitory computer readable medium comprising program instructions stored thereon for performing transmitting, from a user equipment to a network element, an indication in a random access message. The indication can be configured to indicate to the network element as to whether the user equipment has one receive branch or two receive branches. The program instructions may also be for receiving a response from the network element based on the determination. The program instructions may further be for communicating, by the user equipment, with the network based on the determination that the user equipment has one receive branch or two receive branches.

A computer program comprising instructions stored thereon for performing receiving, from a user equipment, an indication in a random access message. The instructions may also be for performing determining whether the user equipment has one receive branch or two receive branches based on the indication. The instructions may further be for performing communicating with the user equipment based on the determination that the user equipment has one receive branch or two receive branches.

A computer program comprising instructions stored thereon for performing transmitting, from a user equipment to a network element, an indication in a random access message. The indication can be configured to indicate to the network element as to whether the user equipment has one receive branch or two receive branches. The instructions may also be for receiving a response from the network element based on the determination. The instructions may further be for communicating, by the user equipment, with the network based on the determination that the user equipment has one receive branch or two receive branches.

### BRIEF DESCRIPTION OF THE DRAWINGS

For proper understanding of example embodiments, reference should be made to the accompanying drawings, wherein:

FIG. 1 illustrates a contention-based random access procedure;

FIG. 2 illustrates a method according to certain embodiments;

FIG. 3 illustrates a further method according to certain embodiments;

FIG. 4A illustrates an example block diagram of an apparatus, according to an embodiment; and

FIG. 4B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing control of access for devices with different capabilities, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

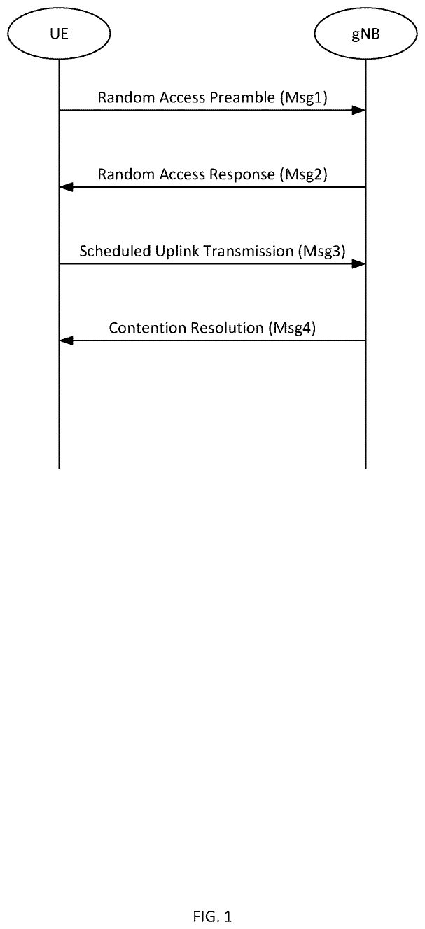

FIG. 1 illustrates a contention-based random access procedure. As shown in FIG. 1, a random access (RA) preamble can be sent as a first message, Msg1, from a user equipment (UE) to a network element, such as a next generation Node B (gNB). The network element may respond with a random access response as a second message, Msg2. The UE may then respond with a scheduled uplink message, for example, a physical uplink shared channel (PUSCH) transmission as a third message, Msg3. Finally, the network element may respond with a fourth message, msg4, which can be a contention resolution message. This approach can be referred to as a four-step random access procedure.

Certain embodiments may relate to a method and/or mechanism by which a network element, such as a gNB, can know the number of receive (Rx) branches of a user equipment (UE). For UE capability signaling, the number of Rx branches for reduced capability (RedCap) can be implicitly indicated by a corresponding capability parameter, maxNumberMIMO-LayersPDSCH. Additional early indication of the number of Rx branches in Msg1, Msg3, and/or MsgA may be possible.

For four-step random access channel (RACH) procedures, such an early indication may appear, for example, in Msg1. The early indication in Msg1 may be configured to be enabled/disabled by system information block (SIB). There may also be the option to provide early indication in Msg3.

A RedCap UE may have various characteristics, such as a bandwidth of up to 20 MHz for frequency range 1 (FR1) and up to 100 MHz for frequency range 2 (FR2). The RedCap UE may support, for example, one or two Rx branches and a corresponding maximum number of downlink (DL) multiple-input multiple-output (MIMO) layers. One option may be have early identification in Msg3 based on dedicated logical channel identifier (L CID) supported.

These options and approaches can be broadly categorized as further physical RACH (PRACH) partitioning, in the case of Msg1 based identification, or added overhead, in the case of Msg3 based identification.

While the network (NW) may not want to use very conservative scheduling for random access response (RAR)/MsgB to support both non-RedCap and RedCap UEs in the same PRACH, configuring enough PRACH resources for RedCap (with Msg1 RedCap UE identification) may present a challenge. On the other hand, the more conservative scheduling of RedCap UEs may only be required for 1Rx RedCap UEs, while the RedCap UEs with 2Rx in most cases may be able to use the PRACH shared with non-RedCap UEs.

When Msg3 based early identification of RedCap UEs is supported, the Msg1 based early identification could be used for identifying requirements for the RAR/MsgB/Msg4 scheduling. This division of labor between Msg1 and Msg3 may provide more flexibility.

In certain embodiments, the network (NW) can configure or indicate whether the RedCap specific PRACH resources configured for Msg1 early identification can be accessed by 1RX or 2RX RedCap UEs or both.

In one option, the RedCap specific PRACH resources are always allowed for 1RX RedCap UEs, assuming access for 1RX RedCap UEs is not barred in the cell.

In one option, if access for 1RX RedCap UEs in the cell is barred and Msg1 early identification is configured, the 2RX RedCap UEs can access the RedCap specific PRACH resources. Additionally, in one further option, in this case, the 2RX RedCap UEs can also access common PRACH resources. In another option, if access for 2RX RedCap UEs in the cell is barred and Msg1 early identification is configured, the 1RX RedCap UEs can access the RedCap specific PRACH resources.

Some cells could be configured to operate in such a way that 1RX would not survive in accessing the cell, hence such UEs may be barred. The 2RX RedCap UEs may operate with reduced bandwidth (BW), for example 20 MHz in frequency range 1 (FR1), or 100 MHz in frequency range 2 (FR2). Thus, frequency diversity may not be used in the same way as for normal NR UEs. Thus, RedCap specific PRACH can be configured for 2RX to take into account their capabilities in the Msg3 transmission so that the access for them can be ensured.

In one option, the NW can configure an RSRP threshold for 1RX or 2RX RedCap UEs to access the RedCap specific PRACH resources. For example, when cell RSRP is below a configured threshold, the 1RX or 2RX RedCap UE may be allowed to access the RedCap specific PRACH resources. In one further option, the RSRP threshold may be separately configured for 1RX and 2RX RedCap UEs. In one option, the RSRP measured by the UE can be the DL RSRP or synchronization sequence block (SSB) RSRP or L3 filtered RSRP which can be compared to the configured RSRP threshold.

In one option, in case the access for 1RX RedCap UEs in the cell is not barred or the RSRP threshold for 2RX UEs is not configured, the RedCap specific PRACH resources may not be allowed for 2RX RedCap UEs.

In one option, the access for 2RX UEs for the RedCap specific PRACH resources may be explicitly allowed/disallowed.

In one option, the access for 2RX UEs for the RedCap specific PRACH resources may be disallowed by configuring an infinity value for the RSRP threshold.

In one option, the access for 1RX UEs for the RedCap specific PRACH resources may be explicitly allowed/disallowed.

In one option, the access for 1RX UEs for the RedCap specific PRACH resources may be disallowed by configuring an infinity value for the RSRP threshold.

In one option, 2RX Redcap UEs may be allowed to access common PRACH resources.

In one option, 2RX Redcap UEs may not be allowed to access RedCap specific PRACH resources.

In one option, 1RX Redcap UEs may be allowed to access common PRACH resources.

In one option, 1RX Redcap UEs may not be allowed to access RedCap specific PRACH resources.

Combinations of the above options are permitted.

In one embodiment, in case both 1RX and 2RX RedCap UEs can access the RedCap specific PRACH resources, the Msg3 based early identification can be used to differentiate between 1RX and 2RX RedCap UEs. For instance, the 1RX or the 2RX RedCap UE can (along with the Msg1 based early identification) indicate the Msg3 based early identification while the (2RX or 1RX RedCap UE, respectively) may not indicate the Msg3 based early identification. In one example, only one type (1RX or 2RX) RedCap UE indicates the Msg3 based early identification when accessing the RedCap specific PRACH resources while any other type of RedCap UE does not.

In certain embodiments, therefore, the Msg3 indication can be used to differentiate between 1RX and 2RX RedCap devices for specific case (for example, 2RX using RedCap RACH when DL RSRP is below threshold upon Random Access initiation). Moreover, in certain embodiments, the Msg3 can be used to indicate RedCap capability (without differentiating 1RX and 2RX devices) for other scenarios. Other scenarios may include, for example, no RedCap RACH exists or RSRP for 1RX or 2RX is above threshold to use common RACH, for instance, the RACH shared with non-RedCap UEs. Thus, the indication does not have to be specific to differentiating 1RX and 2RX but can depend on the situation.

In one embodiment, UE TX capabilities may be taken into account in the above embodiments and options. For example, whether a given UE has one transmission (TX) branch or 2 TX branches or a reduced TX power class, may be taken into account.

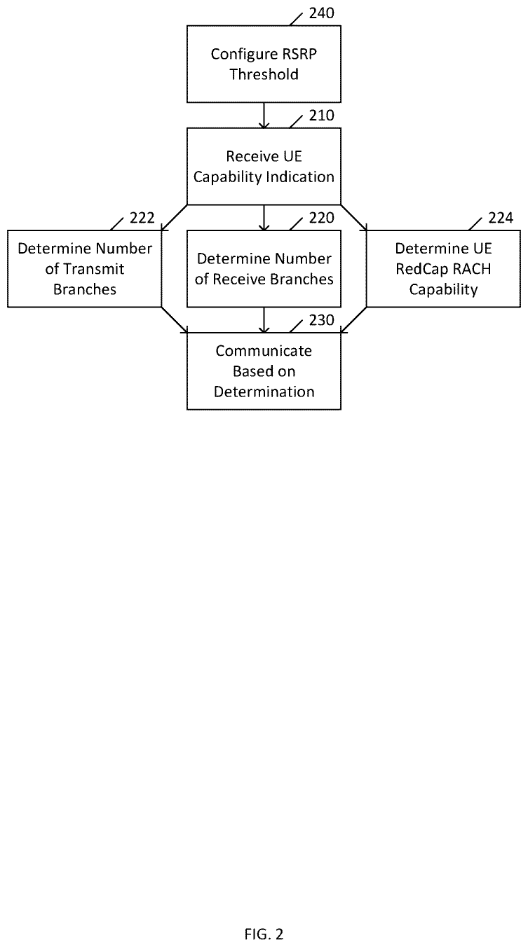

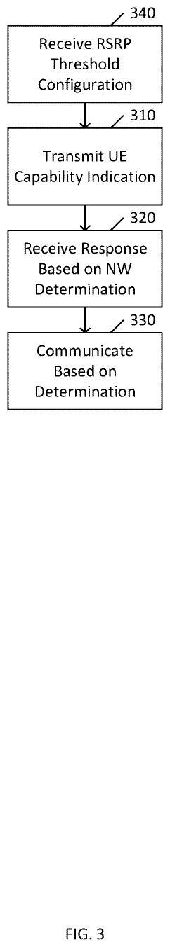

FIG. 2 illustrates a method according to certain embodiments. FIG. 3 illustrates a further method according to certain embodiments. The method of FIGS. 2 and 3 may be usable separately or in combination with one another. For example, the method of FIG. 2 may be a method performed by a serving network element and method of FIG. 3 may be a corresponding method performed by a user equipment served by the serving network element.

FIG. 2 illustrates a method according to certain embodiments. As shown in FIG. 2, a method can include, at 210, receiving, for example at a network element, an indication in a random access message from a user equipment. The random access message can be a third message of a four-message random access procedure, which can also be referred to as a four-step random access procedure. For example, the random access message can be message three (Msg3).

As also shown in FIG. 2, at 220, the method can include determining, for example by the network element, whether the user equipment has one receive branch or two receive branches based on the indication. Other determinations can also be made. The user equipment having one receive branch may be expressed as 1RX UE and may have one receiver chain/branch. The user equipment having two receive branches may be expressed as 2RX UE and may have two receiver chains/branches. The user equipment having 1RX may or may not have more than one transmitter branches. For example, the user equipment having 1RX may have 1TX or 2TX while the user equipment having 2RX may have 1TX or 2TX.

At 222, a number of transmit branches of the UE may be determined from the indication. Likewise, at 224, a capability of UE to operate using RedCap RACH in a particular cell under the particular conditions.

The method can further include, at 230, communicating, by the network element, with the user equipment based on the determination that the user equipment has one receive branch or two receive branches.

The method can also include, at 240, configuring, for example by the network element, a reference signal received power threshold for the user equipment to access a reduced-capability-specific resources. The threshold can be used in various ways. For example, the user equipment may be permitted to access the reduced-capability-specific resources when the reference signal received power is below the threshold. More particularly, the user equipment may be permitted to access the reduced-capability-specific resources in response to the reference signal received power being below the threshold.

The reference signal received power threshold may differ depending on whether the user equipment has one receive branch or two receive branches.

The communicating can include communicating various permissions or prohibitions, which may vary according to implementation. For example, the communicating can include permitting the user equipment to access reduced-capability-specific resources when the user equipment has two receive branches. In other words, in the case when the user equipment has two receive branches, the user equipment may be permitted to access reduced-capability-specific resources. The use of when in the following examples can broadly include any such conditional relationship, wherein the permission or prohibition is conditioned on the condition, in this example the user equipment having two receive branches. As another example, the communicating can further include permitting the user equipment to access common physical random access channel resources.

As another option, the communicating can include permitting the user equipment to access reduced-capability-specific resources when the user equipment has one receive branch. For example, the permitting can be conditioned on the user equipment having one receive branch.

As a further option, the communicating can include forbidding the user equipment to access reduced-capability-specific resources when the user equipment has two receive branches. For example, the forbidding can be conditioned on the user equipment having two receive branches.

As an additional option, the communicating can include permitting access to resources or forbidding access to resources, based on whether the user equipment has one receive branch or two receive branches.

The permitting or forbidding can be performed explicitly. For example, the permitting or forbidding can indicated explicitly by setting a flag or the like. As another option, the forbidding can be performed indirectly, such as by configuring an infinite threshold.

It is noted that FIG. 2 is provided as one example embodiment of a method or process. However, certain embodiments are not limited to this example, and further examples are possible as discussed elsewhere herein.

FIG. 3 illustrates a further method according to certain embodiments. As shown in FIG. 3, the method can include, at 310, transmitting, from a user equipment to a network element, an indication in a random access message from the user equipment. The indication can be configured to permit determination by the network element as to whether the user equipment has one receive branch or two receive branches based on the indication. The determination can correspond to 220 in FIG. 2, and the message transmitted at 310 can be received at 210 in FIG. 2.

The method can also include, at 320, receiving a response from the network element based on the determination. The method can further include, at 330, communicating, by the user equipment, with the network based on the determination that the user equipment has one receive branch or two receive branches.

The method can additionally include, at 340, receiving a configuration, by the network element, of a reference signal received power threshold for the user equipment to access a reduced-capability-specific resources. The user equipment may be permitted to access the reduced-capability-specific resources when the reference signal received power is below the threshold. M ore particularly, the user equipment may be permitted to access the reduced-capability-specific resources in response to the reference signal received power being below the threshold.

It is noted that FIG. 3 is provided as one example embodiment of a method or process. However, certain embodiments are not limited to this example, and further examples are possible as discussed elsewhere herein.

The method of FIG. 3 may also include the options described above with reference to FIG. 2.

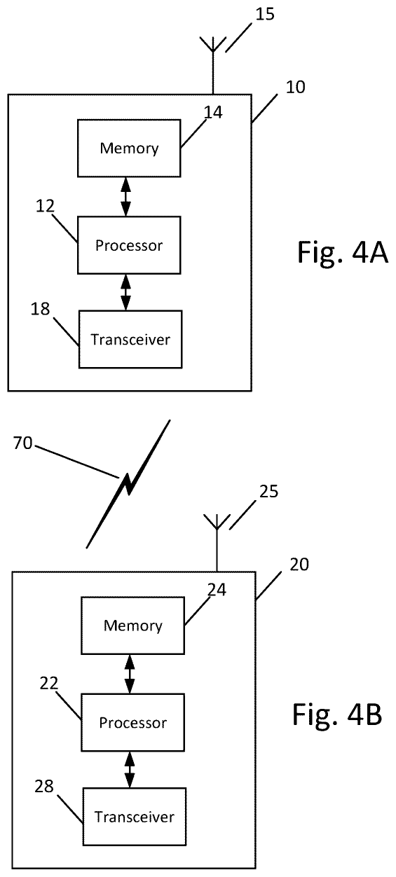

FIG. 4A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 4A.

As illustrated in the example of FIG. 4A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 4A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multi processor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-3, or any other method described herein. In some embodiments, as discussed herein, apparatus 10 may be configured to perform a procedure relating to providing control of access for devices with different capabilities, for example.

FIG. 4B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HM D), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4B.

As illustrated in the example of FIG. 4B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM A symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-3, or any other method described herein. For example, in an embodiment, apparatus 20 may be controlled to perform a process relating to providing control of access for devices with different capabilities, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may provide a way to control access to RedCap RACH resources for UEs having different capabilities, such as different numbers of reception and/or transmission branches and different levels of RSRP.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

PARTIAL GLOSSARY:

| | |
|---|---|
| FR | frequency range |
| NW | network |
| PRACH | physical random access channel |
| RA | random access |
| RACH | random access channel |
| RSRP | reference signal received power |
| RX | receiver |
| UE | user equipment |

1. An apparatus, comprising:
at least one processor; and
at least one memory including computer program instructions,
wherein the at least one memory and the computer program instructions are configured to, with the at least one processor, cause the apparatus at least to perform:
transmitting, to a network element, an indication in a random access message, wherein the indication indicates to the network element as to whether the apparatus has one receive branch or two receive branches.

2. The apparatus of claim 1, wherein the at least one memory and the computer program instructions are configured to, with the at least one processor, cause the apparatus at least to perform:
receiving, from the network element, a response based on the indication.

3. The apparatus of claim 2, wherein the response indicates the apparatus is permitted to access reduced-capability-specific resources conditioned on the apparatus having one receive branch.

4. The apparatus of claim 2, wherein the response indicates the apparatus is forbidden to access reduced-capability-specific resources conditioned on the apparatus having two receive branches.

5. The apparatus of claim 2, wherein the response indicates the apparatus is permitted access to resources or forbidden access to resources, based on whether the apparatus has one receive branch or two receive branches.

6. The apparatus of claim 5, wherein the response explicitly indicates that the apparatus is permitted access to resources or forbidden access to resources.

7. The apparatus of claim 5, wherein the response indicates that the apparatus is forbidden access to resources by configuring an infinite threshold.

8. The apparatus of claim 2, wherein the at least one memory and the computer program instructions are configured to, with the at least one processor, cause the apparatus at least to perform:
communicating, with the network element, based on the indication and the response.

9. The apparatus of claim 8, wherein the communicating comprises accessing reduced-capability-specific resources conditioned on the apparatus having two receive branches.

10. The apparatus claim 8, wherein the communicating further comprises accessing common physical random access channel resources.

11. The apparatus of claim 1, wherein the at least one memory and the computer program instructions are also configured to, with the at least one processor, cause the apparatus at least to perform:
receiving, from the network element, a configuration of a reference signal received power threshold for the apparatus to access a reduced-capability-specific resources, wherein the apparatus is permitted to access the reduced-capability-specific resources in response to the reference signal received power being below the threshold.

12. The apparatus of claim 1, wherein the apparatus is configured with a reference signal received power threshold, and the reference signal received power threshold depends on whether the apparatus has one receive branch or two receive branches.

13. The apparatus of claim 1, wherein the random access message comprises a message three of a four-step random access procedure.

14. An apparatus, comprising:
at least one processor; and
at least one memory including computer program instructions,
wherein the at least one memory and the computer program instructions are configured to, with the at least one processor, cause the apparatus at least to perform:
receiving, from a user equipment, an indication in a random access message;
determining whether the user equipment has one receive branch or two receive branches based on the indication; and
communicating with the user equipment based on the determination that the user equipment has one receive branch or two receive branches.

15. The apparatus of claim 14, wherein the at least one memory and the computer program instructions are also configured to, with the at least one processor, cause the apparatus at least to perform:
configuring a reference signal received power threshold for the user equipment to access a reduced-capability-specific resources, wherein the user equipment is permitted to access the reduced-capability-specific resources in response to the reference signal received power being below the threshold.

16. The apparatus of claim 14, wherein the at least one memory and the computer program instructions are also configured to, with the at least one processor, cause the apparatus at least to perform: configuring a reference signal received power threshold for the user equipment, and wherein the reference signal received power threshold depends on whether the user equipment has one receive branch or two receive branches.

17. The apparatus of claim 14, wherein the communicating comprises permitting the user equipment to access reduced-capability-specific resources conditioned on the user equipment having two receive branches.

18. The apparatus of claim 17, wherein the communicating further comprises permitting the user equipment to access common physical random access channel resources.

19. The apparatus of claim 14, wherein the communicating comprises permitting access to resources or forbidding access to resources, based on whether the user equipment has one receive branch or two receive branches.

20. A method, comprising:
transmitting, from a user equipment to a network element, an indication in a random access message, wherein the indication indicates to the network element as to whether the user equipment has one receive branch or two receive branches.
